(19) United States
(12) Patent Application Publication
(10) Pub. No.: US 2022/0306876 A1
(43) Pub. Date: Sep. 29, 2022

(54) Biodegradable Cellulosic Powders

(71) Applicant: Micro Powders, Inc., Tarrytown, NY (US)

(72) Inventor: Richard Czarnecki, Tarrytown, NY (US)

(21) Appl. No.: 17/656,809

(22) Filed: Mar. 28, 2022

Related U.S. Application Data
(60) Provisional application No. 63/219,537, filed on Jul. 8, 2021.
(60) Provisional application No. 63/167,323, filed on Mar. 29, 2021.

(51) Int. Cl. C09D 7/65; C09D 7/40; C09D 7/42; C05G 5/12

(52) U.S. Cl. CPC C09D 7/65; C09D 7/68; C09D 7/69; C09D 7/42; C05G 5/12

(57) ABSTRACT

A coating composition includes an additive composed of a cellulosic powder which includes microcrystalline cellulose, the cellulosic powder having a maximum particle size equal to or less than 2,000 microns; and at least one constituent mixed with the additive. The additive has 0.01 to 20 wt % based on a total amount of the coating composition being 100 wt %. The coating additive is mixed in the composition to modify gloss, surface durability, texturing, and/or haptic properties.

### TECHNICAL FIELD

The present invention relates to the use of biodegradable cellulosic powders as an additive in coating compositions. The present invention also relates to coating compositions containing cellulosic powders, such as granular cellulose, cellulose acetate, and/or microcrystalline cellulose (MCC) powders. The present invention also relates to coatings made with the coating compositions containing granular cellulose, cellulose acetate and/or microcrystalline cellulose (MCC) powders.

### BACKGROUND

Micronized wax additives have been used to modify coatings for decades. They can provide a wide range of properties, including surface protection, gloss reduction, water repellency, and texturizing. These additives are typically based on low molecular weight polymeric materials, including polyethylene, polypropylene, and other synthetic materials. Micronized waxes can modify paints, inks, industrial coatings, and agricultural treatments. Micronized wax additives can also be used in cosmetics and personal care products, providing properties that include dry binding, thickening, mattifying, and texturizing.

A more and more relevant problem associated with synthetic petrochemical based polymers, such as the above-mentioned waxes, is their low biodegradability. One solution is to employ a coating additive based on a biodegradable material, typically a natural or naturally derived starting material. For example, coating additives based on carnauba wax have been used for decades as modifiers for paints, inks and coatings. However, many biodegradable materials do not have the hardness, high melting point, and durability of their synthetic petroleum based analogs.

### SUMMARY

The object of the present invention is to find a biodegradable material with high melting point that can be size reduced into both ultrafine and coarse additive powders. These additive powders provide a range of surface functionality including gloss reduction, polishing resistance and surface durability, texturizing, and haptics.

In the context of the present invention, it has been found that the above-stated objects can be achieved by the use of cellulose acetate powder. Cellulose acetate is the acetate ester of cellulose and is made by reacting cellulose with acetic acid. Each anhydroglucose unit in a cellulose chain has three hydroxyl groups where ester substitution (such as acetate substitution) may occur. Cellulose esters may be formed by reacting cellulose and an acid anhydride yielding a carboxylic acid and a cellulose ester. The number of carbon atoms in the ester substituent is the same as the number of carbon atoms in the carboxylic acid and is one half of the number of carbon atoms in the acid anhydride. Cellulose acetate is used as a film base in photography, as a component in some coatings, and as a frame material for eyeglasses. It is also used as a synthetic fiber in the manufacture of cigarette filters and playing cards. In photography, cellulose acetate film replaced nitrate film in the 1950s, for being far less flammable and cheaper to produce.

Cellulose acetate typically has a melting point exceeding 230° C., much higher than many other naturally derived and biodegradable materials such as carnauba wax, which melts at around 83-86° C. Cellulose acetate typically decomposes at temperatures above 180° C.

In the context of the present invention, it has also been found that the above-stated objectives can be achieved by the use of microcrystalline cellulose (MCC) powder. Microcrystalline cellulose is sometimes referred to as refined wood pulp. As a naturally occurring polymer, microcrystalline cellulose is composed of glucose units connected by a 1-4 beta glycosidic bond. These linear cellulose chains are bundled together as microfibril spiraled together in plant cell walls.

Each microfibril exhibits a high degree of three-dimensional internal bonding resulting in a crystalline structure that is insoluble in water and resistant to reagents. There are, however, relatively weak segments of the microfibril with weaker internal bonding. These are called amorphous regions; some argue that they are more accurately called dislocations, because of the single-phase structure of microfibrils. The crystalline region is isolated to produce microcrystalline cellulose.

Microcrystalline cellulose typically has a melting point exceeding 230° C., much higher than many other naturally derived and biodegradable materials such as carnauba wax, which melts at around 83-86° C. For example, microcrystalline cellulose may melt at over 500° C. and start to decompose above 250° C.

In the context of the present invention, it has been found that the above-stated objects can be achieved by the use of granular cellulose. Granular cellulose can be derived from a variety of natural plant-based sources including beech, oak and birch trees. Granular cellulose has no melting point and begins to decompose at temperatures above 315° C.

The present invention accordingly provides the use of biodegradable cellulosic powders, such as granular cellulose, cellulose acetate, and/or microcrystalline cellulose (MCC) powders, as additives in coating compositions.

The resulting accumulation of non-biodegradable materials in the environment leads to an environmental impact. For this reason, cellulose acetate, microcrystalline cellulose (MCC), and/or granular cellulose can be employed as an alternative source of raw material for synthetic polymers. Such cellulosic substances have adequate biodegradability, unlike petrochemical-based polymers.

The present invention additionally provides a coating composition comprising cellulose-based powder, including powders based on granular cellulose, cellulose acetate, and/or microcrystalline cellulose (MCC). Furthermore, the present invention provides a coating which has been produced with the coating composition comprising granular cellulose powder, cellulose acetate powder, and/or microcrystalline cellulose powder on a substrate.

Additive powders based on granular cellulose, cellulose acetate, or microcrystalline cellulose can effectively lower coating gloss to ranges from satin to eggshell to matte. Furthermore, the coating compositions or coatings according to the present invention have outstanding properties depending on the particle size of the powder. Finer grades provide surface durability, while coarser grades provide gloss reduction, texturing, and haptic effects. In addition, the cellulose acetate powders, microcrystalline cellulose powders, and granular cellulose powders are primarily based on natural raw materials, so that in the coating compositions and coatings of the invention, the proportion of petrochemical materials can be reduced and still the described excellent properties can be achieved.

Other features and aspects of the present teachings will become apparent from the following detailed description. This summary is not intended to limit the scope of the present teachings, which is defined by the claims.

### DETAILED DESCRIPTION

The cellulose acetate powders, microcrystalline cellulose (MCC) powders, and/or granular cellulose powders are used according to the present invention as additives, in particular as gloss reduction agents, in coating compositions. Additives are conventionally understood to mean auxiliaries or substances which are added to a system, for example a coating composition, to give this system or a system produced therefrom, for example a coating, specific properties that may include surface durability, texture, and/or haptic effects. Of course, the cellulose acetate powders, microcrystalline cellulose powders, or granular cellulose powders can also be used as additives which influence or enhance several different properties of coating compositions and/or coatings, for example several of the above properties. This means that the cellulose acetate powders, microcrystalline cellulose powders, or granular cellulose powders can also be used as additives with multiple functions.

Cellulose acetate (formula: C₆H₇O₂(OH)₃), basically a chain of glucose molecules, is an industrial compound that is used in many important products every day. It is an acetate ester used mostly as fiber material in industries. Cellulose is derived from wood pulp or linters of cotton. This is not 100% pure cellulose. Instead, it is 6-7% concentrated cellulose in water. In the displacement and acetylation phase, firstly water or impure acetic base used to make cellulose suspension is replaced with 100% pure acetic acid. This process is done with a displacement filter. Then the suspension is sent to the acetylation kneader where acetylation takes place and dough acetic syrup is produced. This syrup is mixed with certain amounts of water to avoid excessive anhydride and introduce certain amount of water for next stage of process. This dough mixture is then sent for hydrolysis. After the end of hydrolysis, cellulose acetate with acetic acid content around 54-55 percent is obtained. The material is further refined, purified and dried, and can be isolated as solid flaked material or spun into filaments.

Microcrystalline cellulose (MCC) is pure partially depolymerized cellulose synthesized from α-cellulose precursor. The MCC can be synthesized by different processes such as reactive extrusion, enzyme mediated, mechanical grinding, ultrasonication, steam explosion and acid hydrolysis. The later process can be done using mineral acids such as H₂SO₄, HCl and HBr as well as ionic liquids. The role of these reagents is to destroy the amorphous regions leaving the crystalline domain The degree of polymerization is typically less than 400. The MCC particles with size lower than 5 μm must not be more than 10%.

Solid cellulose acetate and microcrystalline cellulose are brittle materials, typically provided as a flake, pellet, or coarse powder. The solid cellulose acetate, microcrystalline cellulose, and granular cellulose can be ground or micronized as desired. In this way, the particles or the powder, if desired, can be further comminuted and, if appropriate, a more specific, narrower particle size distribution can be achieved. Cellulose acetate, microcrystalline cellulose, and/or granular cellulose from different suppliers were micronized at different intensities by means of a jet mill, mechanical mill, air mill, attrition mill or other size reducing machinery capable of producing cellulosic powder particles. In this case, articles with different particle size distribution were obtained. The particle sizes or size distributions were measured by laser diffraction using a Microtrac, or by screen analysis for coarser grades.

Depending on the final particle size and particle distribution, the additive powder can be used for a range of benefits in paints, inks and coatings described below in Table 1.

According to the present invention, the cellulosic powders are preferred in a coating composition in an amount of from 0.01 to 20% by weight, preferably from 0.5 to 10% by weight, in particular from 1 to 8% by weight, based in each case on the total amount of the coating composition used. This is either just one cellulosic powder or a mix of several different cellulosic powders.

The cellulosic powders may also be used in combination with other coating additives including other gloss reduction agents.

According to the present invention, the coating compositions may be used as it is or include other different compositions. The coating composition may comprise at least one typical polymeric resin as binder and optionally a typical organic solvent and/or water and optionally further typical paint additives. The skilled person will in each case make a corresponding selection according to the requirements of the respective individual case on the basis of his specialist knowledge.

Examples of polymeric resins as binders include, but are not limited to, the known polyurethane, polyester, polyester polyol, acrylic (such as polyacrylate and polymethacrylate), polyester acrylate, epoxy acrylate, polyether acrylate, urethane acrylate, epoxy, and/or alkyd resins. The polymeric resins may be self-crosslinking or externally crosslinking. This is known to mean that the crosslinking functional groups of the resins can be in one and the same resin or in different organic compounds. In externally crosslinking systems, for example, aminoplast resins and monomeric and/or polymeric blocked and/or free polyisocyanates may also be present as crosslinking agents, in particular polyisocyanates, which may then react with hydroxy groups of a polymeric resin, for example, so that a film is formed. In a preferred externally crosslinking system, at least one hydroxy-functional polymeric resin as binder, in particular a hydroxy-functional polyester, is combined with at least one polyisocyanate as crosslinking agent.

In particular, according to the present invention, acrylic, polyester-acrylate and/or polyester-polyol resins are used as binders. In particularly preferred embodiments, in the case of water-based coating compositions, an acrylic resin is used, in solvent-based coating compositions, a combination of a hydroxy-functional polyester with at least one polyisocyanate is used, and in solvent-free, purely reactive diluent-based coating compositions, which are advantageously radiation-curing in the present invention, a polyester acrylate resin is used.

The total proportion of the polymeric resins as binders and the optionally present organic compounds as crosslinking agents on the coating compositions depends on the individual case and can vary widely. In certain embodiments of the present invention, the proportion may be, for example, in the range from 10 to 90% by weight, preferably from 15 to 80% by weight, more preferably from 25 to 60% by weight, based in each case on the total amount of the coating composition, lie. But are also possible lower or higher, especially higher shares, for example when the coating composition is a powder paint. In this case, the proportion can be up to 99.5 wt. %.

The coating composition can be physically and/or chemically curable and/or radiation-curing, for example, depending on the type of the polymeric resins used and, if appropriate, crosslinkers. The coating composition may be a one, two or more component system. The person skilled in the art will be able to select from the possibilities mentioned, depending on the individual requirements.

The coating composition optionally contains a solvent. Suitable solvents are the typical organic solvents known to the person skilled in the art, for example, but not exclusively, aliphatic, cycloaliphatic, aromatic solvents, typical ethers, esters and/or ketones, for example butylglycol, butyldiglycol, butylacetate, methylisobutylketone, methylethylketone. Also used as a solvent is water. The coating composition may be, for example, water-based or solvent-based. In the context of the present invention, water-based is understood to mean that the coating composition contains mainly water as solvent. In particular, in a water-based coating composition, not more than 20% by weight, especially not more than 10% by weight, of organic solvents, based on the total amount of solvent, are contained in the coating composition. Within the scope of the present invention, a coating composition which contains not more than 10% by weight, preferably not more than 5% by weight, particularly preferably not more than 2% by weight of water, based on the total amount of solvents, is considered to be solvent-based. Of course, the coating composition may also contain more balanced proportions of organic solvent and water as compared to the above-specified proportions that establish the water-based or solvent-based character.

The proportion of solvent in the coating composition may, for example, be in the range of 0-84.99% by weight, based on the total amount of the coating composition.

The coating composition optionally contains a reactive diluent instead of the solvent or in addition to the solvent. As reactive diluents, the typical, generally known to those skilled, generally low-viscosity compounds which diluently act on the coating composition and remain by chemical reaction in the film, are used. For example, the mono-, di-, and/or triacrylates known to those skilled in the art can be used as reactive diluents in, for example, radiation-curing systems, for example dipropylene glycol diacrylate.

The coating composition may, for example, also be a powder coating. Powder coatings are organic, mostly duroplastic coating powders with a solids content of 100%. Coating with powder coatings requires no solvents.

It is of particular advantage that both water-based and solvent-based and solvent-free coating compositions, such as, for example, powder coatings or coating compositions based on reactive diluents, can be used within the scope of the inventive use. The breadth of applicability of the use according to the invention is therefore very large.

In addition, the coating composition to be used in the present application may still contain pigments or fillers. The choice of such pigments or fillers can be selected by the skilled person according to the requirements of the individual case.

Preferably, however, the coating compositions to be used are substantially free of pigments and fillers. The coating compositions to be used are, in particular, clearcoats.

In addition, the coating composition to be used in the present application may still contain different paint additives. Such paint additives are known to the person skilled in the art and can be selected therefrom according to the requirements of the individual case on the basis of his specialist knowledge. For example, but not exclusively, photoinitiators, defoamers, wetting agents, film-forming auxiliaries such as cellulose derivatives (for example cellulose nitrate and cellulose acetate), leveling agents, dispersants and/or rheology-controlling additives may be used.

Furthermore, a coating composition containing cellulose acetate powder, microcrystalline cellulose (MCC) powder, and/or granular cellulose powder is the subject of the present invention. The embodiments and preferred embodiments described above in connection with the use according to the present invention with regard to the cellulose acetate powder, microcrystalline cellulose (MCC) powder, and/or granular cellulose powder to be used and the coating compositions also apply correspondingly to the coating composition comprising cellulose acetate powder, microcrystalline cellulose powder, and/or granular cellulose powder according to the present invention.

The preparation of the coating composition according to the present invention is carried out by the method familiar to the person skilled in the art and has no special features. The known methods are used, such as, for example, the gradual addition with stirring and mixing of the constituents of the coating composition in customary and known mixing units, such as stirred tanks or dissolvers.

Likewise provided by the present invention is a coating which has been produced using the coating composition according to the present invention.

The coating is produced by application of the coating composition according to the present invention to a substrate and subsequent curing of the applied coating composition.

The coating is also produced by the application techniques familiar to the person skilled in the art on a substrate and subsequent curing processes.

The application is carried out, for example, but not exclusively, by the known spraying, spraying, brushing, rolling, pouring, impregnating and/or dipping methods.

After application of the coating composition to a substrate, the curing is carried out by conventional methods. For example, the applied coating composition may be physically drying, thermal, and/or curable using actinic radiation (radiation curable), preferably UV radiation, as well as electron beam radiation. The thermal cure may be, for example, in the range of about 10° C. to about 250° C., depending on the nature of the coating composition and/or the substrate. The duration of the curing is also individually dependent on the type of curing process (thermal or actinic), the type of coating composition used and/or the substrates, for example. For example, the cure may last between 1 minute and several hours or even days, for example up to 10 days. The substrate can be moved or even resting. The curing conditions can easily be adapted by a person skilled in the art on the basis of his specialist knowledge, depending on the individual case.

The layer thicknesses are 1 μm to 5 mm, preferably 3 μm to 5 mm, and more preferably 10 μm to 2 mm. Here, too, it depends on the individual conditions and the individual field of application.

Substrates which can be used in the context of the present invention are any conceivable substrates for coating compositions, in particular but not exclusively, the coatings of the invention are applied to metal, glass, plastics, wood, leather, artificial leather, ceramics, paper, textiles in various designs and forms.

The coating according to the present invention may be a single-layer coating or a multi-layer coating. In the case of a multi-layer coating, the coating composition with which the individual layers of the coating according to the present invention are prepared may be the same or different. However, it is essential to the invention that at least one of the coating compositions used is a coating composition according to the invention, that is to say therefore contains cellulose acetate powder microcrystalline cellulose powders, and/or granular cellulose powders.

Additionally, additive powders based on cellulose acetate, microcrystalline cellulose, and/or granular cellulose can be used to modify agricultural products, including seed treatment coatings and granulated fertilizers. The cellulosic powder provides surface durability, lubricity, anti-dusting, blocking resistance, and other properties desirable in an agricultural product.

By the use according to the present invention, it is possible to achieve excellent gloss reduction efficiency of coating compositions or an excellent degree of gloss reduction of coatings. The significant reduction in brightness goes hand in hand with further outstanding properties such as surface durability, antiblocking, texturing and haptics. It achieves an excellent balance of the aforementioned properties. In addition, the cellulose acetate powder, the microcrystalline cellulose (MCC) powder, and/or granular cellulose powder to be used according to the present invention are biodegradable and therefore more preferable than, for example, gloss reduction agents based on petrochemical raw materials. Obviously, the described advantageous properties also apply to the coating composition according to the present invention and the coating according to the present invention.

The invention will be described in more detail below with reference to examples in Table 1.

TABLE 1

| | Mean | Maximum | Maximum | |
|---|---|---|---|---|
| | particle | particle | particle | |
| | size in | size in μm | size | |
| Example | μm (mv): | (D100): | (mesh): | Primary benefit: |
| 1 | 3-6 | 15.56 | | Surface durability, |
| | | | | blocking resistance |
| | 8-12 | 31 | | Gloss reduction, |
| | | | | burnish resistance |
| | 10-15 | 44 | 325 | Gloss reduction, |
| | | | | burnish resistance |
| | 15-25 | 53 | 270 | Gloss reduction, fine |
| | | | | surface texturing |
| | 30-40 | 74 | 200 | Surface texturing, |
| | | | | haptics |
| | 80-100 | 149 | 100 | Moderate surface |
| | | | | texturing and haptics |
| 2 | NA | 300 | 50 | Heavy surface texturing, |
| | | | | nonslip, haptics |
| 3 | 3-6 | 15.56 | | Surface durability, |
| | | | | blocking resistance |
| 4 | NA | 300 | 50 | Heavy surface texturing, |
| | | | | nonslip, haptics |

Note that, for coarse powders above 100 mesh, mean particle size is typically not measured nor specified.

### Example 1: Ultrafine Cellulose Acetate Additive Powder

Cellulose acetate (flakes, pellets, prills, coarse powder or pastilles) are micronized using a jet mill to a mean particle size (mv) of 3.0-6.0 μm and a maximum particle size (D100) of 15.56 μm.

This additive powder is useful to improve surface durability and blocking resistance when used as an additive in industrial paints, inks, and coatings.

### Example 2: Coarse Cellulose Acetate Additive Powder

Cellulose acetate (flakes, pellets, prills, coarse powder or pastilles) are size reduced using a disk, pin, hammer or other suitable mill to a top particle size of 50 mesh (300 μm).

This additive powder is useful to add texturing, antislip properties, and haptic effects in industrial paints and coatings.

### Example 3: Ultrafine Microcrystalline Cellulose Additive Powder

Microcrystalline cellulose (flakes, pellets, prills, coarse powder or pastilles) are micronized using a jet mill to a mean particle size (mv) of 3.0-6.0 μm and a maximum particle size (D100) of 15.56 μm.

This additive powder is useful to improve surface durability and blocking resistance when used as an additive in industrial paints, inks, and coatings.

### Example 4: Coarse Microcrystalline Cellulose Additive Powder

Microcrystalline cellulose (flakes, pellets, prills, coarse powder or pastilles) are size reduced using a disk, pin, hammer or other suitable mill to a top particle size of 50 mesh (300 μm).

This additive powder is useful to add texturing, antislip properties, and haptic effects in industrial paints and coatings.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification.

What is claimed is:

1. A coating composition comprising:
an additive composed of a cellulosic powder which includes microcrystalline cellulose, the cellulosic powder having a maximum particle size equal to or less than 2,000 microns; and
at least one constituent mixed with the additive;
wherein the additive has 0.01 to 20 wt % based on a total amount of the coating composition being 100 wt %.

2. The coating composition of claim 1, wherein the additive has 0.5 to 10 wt % based on the total amount of the coating composition being 100 wt %.

3. The coating composition of claim 2, wherein the additive has 1 to 8 wt % based on the total amount of the coating composition being 100 wt %.

4. The coating composition of claim 1, wherein the at least one constituent comprises an organic solvent and/or water.

5. The coating composition of claim 1, wherein the at least one constituent comprises a polymeric resin as a binder, an organic compound as a crosslinking agent, and/or a reactive diluent.

6. The coating composition of claim 1, wherein the at least one constituent comprises a paint additive;
wherein the paint additive includes a photoinitiator, a defoamer, a wetting agent, a film-forming auxiliary, a leveling agent, a dispersant, or a rheology-controlling additive.

7. The coating composition of claim 1, wherein the cellulosic powder has a mean particle size ranging from 0.1 microns to 44 microns.

8. The coating composition of claim 1, wherein the cellulosic powder has a mean particle size ranging from about 44 microns to about 100 microns.

9. The coating composition of claim 1, wherein the cellulosic powder has a mean particle size ranging from about 100 microns to about 2,000 microns.

10. The coating composition of claim 1, wherein the additive modifies gloss, surface durability, texturing, and/or haptic properties of the coating composition.

11. The coating composition of claim 1, wherein the coating composition is a paint, an ink, or an industrial coating.

12. The coating composition of claim 1, wherein the coating composition is incorporated into a seed treatment coating or a fertilizer granulation.

13. A coating additive comprising:
a cellulosic powder which includes microcrystalline cellulose;
the cellulosic powder having a maximum particle size equal to or less than 2,000 microns; and
wherein the coating additive is mixed in a composition to modify gloss, surface durability, texturing, and/or haptic properties.

14. The coating additive of claim 13, wherein the cellulosic powder has a mean particle size ranging from about 0.1 microns to about 44 microns.

15. The coating additive of claim 13, wherein the cellulosic powder has a mean particle size ranging from about 44 microns to about 100 microns.

16. The coating additive of claim 13, wherein the cellulosic powder has a mean particle size ranging from about 100 microns to about 2,000 microns.

17. The coating additive of claim 13, wherein the composition is a paint, an ink, or an industrial coating.

18. The coating additive of claim 13, wherein the composition is incorporated into a seed treatment coating or a fertilizer granulation.
